(19) United States
(12) Patent Application Publication
(10) Pub. No.: US 2023/0153547 A1
(43) Pub. Date: May 18, 2023

(54) System for accurate video speech translation technique and synchronisation with the duration of the speech

(71) Applicant: Ogoul Technology Co. W.L.L., Doha (QA)

(72) Inventors: SALAH M. WERFELLI, MORGAN HILL, CA (US); SAM L. APPLETON, MORGAN HILL, CA (US); KHALED JASSIM J. S. AL-JABER, DOHA (QA); TANWIR ZAFAR SYEDMOHAMMAD, TRACY, CA (US)

(21) Appl. No.: 17/525,307

(22) Filed: Nov. 12, 2021

(51) Int. Cl. G06F 40/58; G06F 40/166; G10L 15/22; G10L 13/02; G10L 25/57; G10L 15/30; G10L 15/18; H04N 5/278; H04L 12/58

(52) U.S. Cl. CPC G06F 40/58; G06F 40/166; G10L 15/22; G10L 13/02; G10L 25/57; G10L 15/30; G10L 15/18; H04N 5/278; H04L 51/10

(57) ABSTRACT

The present invention relates to a system for accurate video speech translation and synchronisation. The present invention particularly related to a system for accurate video speech translation and synchronisation with the duration of the speech. The present invention discloses a system to minimise the inaccuracy in the translation and also synchronise the translated speech with the duration of audio and video elements.

### CROSS REFERENCE OF RELATED PATENTS

This application claims the benefit of U.S. Provisional Application No. 63/113,058, filed Nov. 12, 2020; each of the foregoing applications is incorporated by reference herein in its entirety.

### FIELD OF THE INVENTION

The present invention relates to a system for accurate video speech translation and synchronisation. The present invention particularly related to a system for accurate video speech translation and synchronisation with the duration of the speech. The present invention discloses a system to minimise the inaccuracy in the translation and also synchronise the translated speech with the duration of audio and video elements.

### BACKGROUND OF THE INVENTION

Video messaging is becoming an optimal form of communication. Video messaging users are now able to communicate with friends, family, and colleagues all over the world at negligible costs. Yet language barriers continue to exist inhibiting the effectiveness of video messaging as a world-wide form of communication. Translation software fails to offer a real-time perception of video messaging.

However, translation of speech from audio and video recordings has been a complex task. In most cases flow of translation is to convert speech to text, then translate text to another language and the convert text to speech. During this process accuracy of the translation is compromised. In most cases point of failure is the conversion of speech to text. Inaccurate conversion drills down to incorrect translation and then incorrect translation converts text to speech. Another problem is the synchronization of the translated speech with the duration of the video. Either translated speech concludes significantly earlier than the end of the video or video ends before the translated speech is ended.

In view of the above, the present invention addresses the above two concerns. The invention discloses a system to minimize the inaccuracy in the translation and also synchronize the translated speech with the duration of the audio or video elements.

### BRIEF DESCRIPTION OF FIGURES

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a functional block diagram illustrating one example of functionality implemented as portions of the translation processing application executed in a computing device in the networked environment of FIG. 1 according to various embodiments of the present disclosure.

### DETAILED DESCRIPTION OF THE INVENTION

The present invention may be understood more readily by reference to the following detailed description. It is to be understood that this invention is not limited to the specific devices, methods, conditions or parameters described and/or shown herein and that the terminology used herein is for the example only and is not intended to be limiting of the claimed invention. Also, as used in the specification including the appended claims, the singular forms ‘a’, ‘an’, and ‘the’ include the plural, and references to a particular numerical value includes at least that particular value unless the content clearly directs otherwise. Ranges may be expressed herein as from ‘about’ or ‘approximately’ another particular value when such a range is expressed another embodiment. Also, it will be understood that unless otherwise indicated, dimensions and material characteristics stated herein are by way of example rather than limitation, and are for better understanding of sample embodiment of suitable utility, and variations outside of the stated values may also be within the scope of the invention depending upon the particular application.

Embodiments will now be described in detail. To avoid unnecessarily obscuring the present disclosure, well-known features may not be described substantially or the same elements may not be redundantly described. This is for ease of understanding.

The following description are provided to enable those skilled in the art to fully understand the present disclosure and are in no way intended to limit the scope of the present disclosure as set forth.

In one embodiment of the present invention, a system for accurate video speech translation and synchronisation is disclosed.

Disclosed herein are various embodiments relating to language translation in a video speech application. When a user participates in video speech, a video feed may be shown both to the user and any other participant(s). A participant may speak in a language not understood by other participants. According to various embodiments, a video speech application may be employed to translate the speech to a language understood by other participants.

In one embodiment of the present invention, the aforesaid system to accurately translate speech from video recordings follows below flow:
Convert Speech to Text of the recording
Save the converted text in an editable file
Review the text for accuracy and edit where text of the speech is incorrect
Enter code to identify pauses/assisted by the time transcribed text
Save the script and pass it through translation engine
Save the translated text
Convert text to speech and overlay the speech with the video recording.

In one embodiment of the present invention, logic and algorithm to synchronize the translated speech with video duration:
Find the total length of original video
Calculate total length of translated speech recording
Find the difference in the length of original video

(Difference=length of video—duration of translated speech)
Apply the below logic:
   If (length of video—duration of translated speech) is greater than zero then
      Pause Time=Difference/Number of pauses
      Add Pause time to each pause during text to speech conversion
   If (length of video—duration of translated speech) is less than zero then
      Calculate Time Difference factor

Time difference Factor=1−|Difference|/Duration of Translated Speech
Increase the narration speed of the speech by the Time Difference Factor
If (length of video—duration of translated speech) is equal to zero then
   No action.

In some cases, video messaging may be conducted on a computer equipped with a camera and a microphone. In other cases, mobile phone technology has advanced to where a significant number of phones have the necessary hardware, processing power, and bandwidth to participate in video messaging. In the following discussion, a general description of a system for translation in video messaging software and its components is provided, followed by a discussion of the operation of the same.

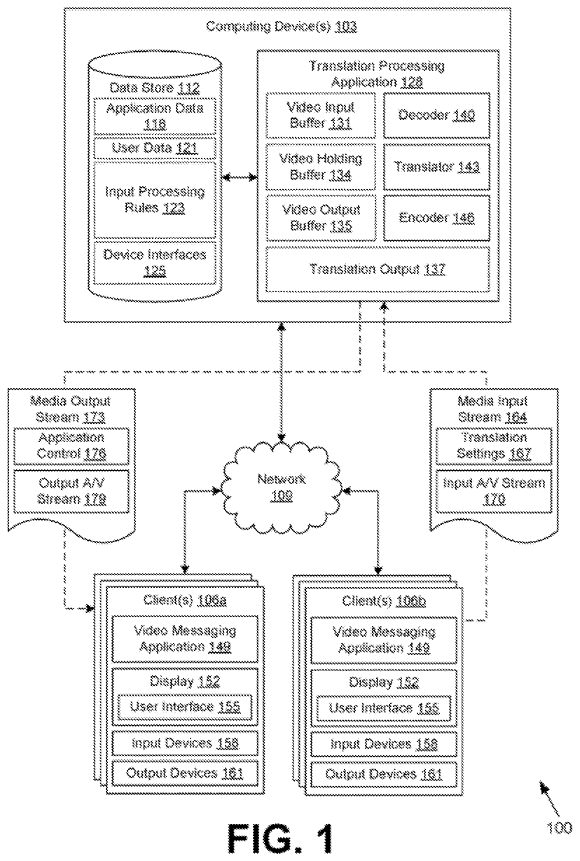

With reference to FIG. 1, shown is a networked environment 100 according to various embodiments. The networked environment 100 includes a computing device 103 in data communication with one or more clients 106 via a network 109. The network 109 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

Various applications and/or other functionality may be executed in the computing device 103 according to various embodiments. Also, various data is stored in a data store 112 that is accessible to the computing device 103. The data store 112 may be representative of a plurality of data stores as can be appreciated. The data stored in the data store 112, for example, is associated with the operation of the various applications and/or functional entities described below.

The components executed on the computing device 103, for example, include a translation processing application 128 and other applications, services, processes, systems, engines, or functionality not discussed in detail herein. The translation processing application 128 includes, for example, a video input buffer 131, video holding buffer 134, video output buffer 135, translation output 137, decoder 140, translator 143, encoder 146, and potentially other subcomponents or functionality not discussed in detail herein. The translation processing application 128 is executed in order to detect and translate speech. For example, the translation processing application 128 may place packets of an input audio/video (A/V) stream 170 in video input buffer 131 to await decoding, translation, and encoding. The translation processing application 128 may output encoded A/V signal comprising the original visual component, with a delay imposed, and a translation output as will be described.

The data stored in the data store 112 includes, for example, application data 118, user data 121, input processing rules 123, device interfaces 125, and potentially other data. Application data 118 may include, for example, application settings, translation settings, user-specific settings, and/or any other data that may be used to describe or otherwise relate to the application. User data 121 may include, for example, user-specific application settings, translation settings, geographic locations, messaging application user name, language preferences, phone numbers, and/or any other information that may be associated with a user.

Input processing rules 123 may include, for example, settings or restraints on language translation, language translation algorithms, language translation rules, predefined language translation thresholds, and/or any other information that may be associated with input processing. Device interfaces 125 may include data relating to a display, a user interface, and/or any other data pertaining to an interface.

Each of the clients 106 a/b is representative of a plurality of client devices that may be coupled to the network 109. Each client 106 a/b may comprise, for example, a processor-based system such as a computer system. Such a computer system may be embodied in the form of a desktop computer, a laptop computer, a personal digital assistant, a cellular telephone, set-top box, music players, web pads, tablet computer systems, game consoles, or other devices with like capability.

Each client 106 a/b may be configured to execute various video messaging applications 149 such as a video conferencing application, a video voicemail application, and/or other applications. Video messaging applications 149 may be rendered by a browser, for example, or may be separate from a browser. Video messaging applications 149 may be executed, for example, to access and render user interfaces 155 and video streams on the display 152. The display 152 may comprise, for example, one or more devices such as cathode ray tubes (CRTs), liquid crystal display (LCD) screens, gas plasma-based flat panel displays, LCD projectors, or other types of display devices, etc.

The input devices 158 may be executed to generate a video data stream. The input devices 158 may comprise, for example, a microphone, a keyboard, a video camera, a web-camera, and/or any other input device. The output devices 161 may be executed to render a video and/or audio data stream. The output devices 161 may comprise, for example, speaker(s), lights, and/or any other output device beyond the display 152.

Next, a general description of the operation of the various components of the networked environment 100 is provided. To begin, a user may participate in a video conference via video messaging application 149. An input device 158, such as a camera and a microphone, may capture audio and/or video data corresponding to the participant's activity and speech. The audio and/or video data is communicated to the translation processing application 128 as an input A/V stream 170 via media input stream 164. The desired translation language may be communicated via media input stream 164 as translation settings 167. The audio and/or video data may be placed in video input buffer 131 to await processing. The translation processing application 128 may begin processing the data in video input buffer 131 in a first in, first out (FIFO) method.

Processing the data residing in video input buffer 131 may involve decoding the A/data to separate the visual component from the audio component in the decoder 140. The visual component may be stored in video holding buffer 134 while the audio component is translated. Alternatively, the A/V signal may be stored in video input buffer 131 and/or video holding buffer 134 where the decoder 140 merely obtains a copy of the audio component to translate. The audio component may be processed by the translator 143 to convert the audio data to text data using, for example, a speech recognition algorithm. The text data reflects what was spoken by the user in the user's spoken language. Via translator 143, the text data may be translated to other text data comprising a second language. Translator 143 may further comprise an algorithm that estimates the accuracy of the translation. The accuracy of the translation may also be considered a confidence level calculated by translation processing application 128 that the translation is correct.

According to various embodiments, the translation output 137 may comprise audio, text, or any other form embodying speech in a second language. The translated text data may be stored as translation output 137 to provide a written log of the communication and/or to later encode the video with subtitles via the encoder 146. The text data comprising the translation may be converted to audio via the encoder 146 by, for example, employing a text-to-speech algorithm. The translated audio data may be stored as translation output 137 to provide an audio log of the communication and/or later encode the video with the translation audio via the encoder 146.

The encoder 146 is configured to combine the translation output 137 with the data residing in the video holding buffer 134. In one embodiment, the encoder 146 may combine the video residing in the video holding buffer 134 with the translated text data as subtitles by synchronizing the text translation output 137 with the previously separated visual component of the video data. In another embodiment, the encoder 146 may combine the video residing in the video holding buffer 134 with the translated audio rendering by synchronizing the audio rendering with the previously separated visual component of the video data. In another embodiment, the encoder 146 may combine the translated text data with the A/V signal residing in the video holding buffer 134 as subtitles by synchronizing the text translation output 137 with the visual component of the A/V signal. The A/V output of the encoder 146 may be stored in video output buffer 135.

Synchronizing the visual component of the video data with the translation output may comprise speeding up or slowing down the play speed of the video data and/or the play speed of translation output 137. For example, the play speed of a video segment depicting a participant speaking in a first language may be adjusted to synchronize the playback of the translation output 137 of a second language with the video segment.

In one embodiment, the synchronization occurs through the encoder 146 in the translation processing application 128 by combining the visual component of the video data with the translation output 137 in computing device(s) 103. For example, the translation processing application 128 may synchronize the audio and video components and encode them to create one MPEG-4 file to transmit to the client(s) 106 via output A/V stream 179. In another embodiment, the visual component of the video data and the translation output 137 may be left separate in the translation processing application 128. In this embodiment, the video messaging application 149 may initiate synchronous playback of the visual component and the translation output 137 in computing device(s) 106. For example, the audio component may be encoded as a WAV file and the video component may be encoded as an MPEG-4 file, both sent to client(s) 106 via media output stream 173 and output A/V stream 179. The video messaging application 149 may play the files simultaneously to have the same effect as the previous embodiment.

The encoded video residing in video output buffer 135 comprising the translation output 137 is transmitted to client(s) 106 via media output stream 173. Application control 176 provides data corresponding to initiating playback of output A/V stream 179 in video messaging application 149. Additionally, application control 176 may comprise data that controls indicators in the video messaging application 149 that may display the estimated accuracy of the translation and/or indicator icons corresponding to whether a translation is being generated by the client sending the output A/V stream 179.

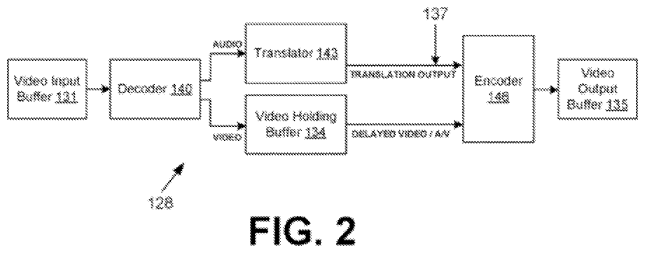

Referring next to FIG. 2, shown is a functional block diagram that provides one example of the operation of a portion of translation processing application 128 according to various embodiments. It is understood that the functional block diagram of FIG. 2 provides merely an example of the many different types of functional arrangements that may be employed to implement the operation of the portion of the language translation as described herein.

A/V data is initially stored in video input buffer 131 and is accessed by decoder 140 to separate the audio component from the video component, or at least obtain a copy of the audio component. Frames of the video component are then stored in video holding buffer 134. Alternatively, if the decoder 140 obtains a copy of the audio component, the A/V signal may be stored in video holding buffer 134. The audio component then is provided to translator 143 where the audio comprising a first language is converted to text comprising the first language. Further, in translator 143, the text comprising the first language may be translated to text comprising a second, translated language shown as translation output 137. Also, translator 143 may be further configured to render the text comprising a second language into an audio version of the translation as audio translation output 137.

The video component or A/V signal stored in video holding buffer 134 is accessed by the encoder along with the translation output 137. The encoder 146 may then combine translation output 137 with either the previously separated video component or the A/V signal to create a combined video file stored in video output buffer 135. By combining the translation output 137 with the video in video holding buffer 134, a delay may be imposed in the video or A/V signal that is equivalent to the time elapsed in generating the translation output 137.

Although the translation processing application 128 (FIG. 1), and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Also, any logic or application described herein, including the translation processing application 128, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed:

1. A system for accurate video speech translation technique and synchronisation with the duration of the speech comprising:
saving the converted text in an editable file;
reviewing the text for accuracy and edit where text of the speech is incorrect;
entering code to identify pauses/assisted by the time transcribed text;
saving the script and pass it through translation engine;
saving the translated text;
converting text to speech and overlay the speech with the video recording.

2. The system for accurate video speech translation as claimed in claim 1 wherein, the aforesaid system further consists of video messaging may be conducted on a computer equipped with a camera and a microphone.

3. The system for accurate video speech translation as claimed in claim 1 wherein, the aforesaid system is supported by network selected from the internet, intranets, extranets, wide area networks (WANs), local area networks (LANs), wired networks, wireless networks, or other suitable networks, etc., or any combination of two or more such networks.

4. The system for accurate video speech translation as claimed in claim 1 wherein, the aforesaid system is connected to a server computer or any other system providing computing capability.

5. The system for accurate video speech translation as claimed in claim 1 wherein, the aforesaid system may be connected to a plurality of computing devices may be employed that are arranged, for example, in one or more server banks or computer banks or other arrangements. For example, a plurality of computing devices together may comprise a cloud computing resource, a grid computing resource, and/or any other distributed computing arrangement.

6. The system for accurate video speech translation as claimed in claim 1 wherein, the aforesaid system executes a translation processing application and other applications, services, processes, systems, engines, or functionality.

7. The system for accurate video speech translation as claimed in claim 1 wherein, the aforesaid system further executes the translation processing application includes, for example, a video input buffer, video holding buffer, video output buffer, translation output, decoder, translator, encoder, and potentially other subcomponents or functionality.

8. The system for accurate video speech translation as claimed in claim 1 wherein, the aforesaid system is configured to execute various video messaging applications such as a video conferencing application, a video voicemail application, and/or other applications.

8. The system for accurate video speech translation as claimed in claims 1 and 8 wherein, the video messaging applications are rendered by a browser, for example, or may be separate from a browser.

9. The system for accurate video speech translation as claimed in claim 1 wherein, the input device is executed to generate a video data stream and is selected from a microphone, a keyboard, a video camera, a web-camera, and/or any other input device.

10. The system for accurate video speech translation as claimed in claim 1 wherein, the output device is executed to render a video and/or audio data stream and the output device is selected from speaker(s), lights, and/or any other output device beyond the display.
